(19) United States
(12) Patent Application Publication
(10) Pub. No.: US 2009/0249235 A1
(43) Pub. Date: Oct. 1, 2009

(54) APPARATUS AND METHOD FOR SPLITTING AND DISPLAYING SCREEN OF TOUCH SCREEN

(75) Inventors: Bo-Keun KIM, Suwon-si (KR); Se-Jin KWAK, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/405,567

(22) Filed: Mar. 17, 2009

(30) Foreign Application Priority Data
Mar. 25, 2008 (KR) 10-2008-0027356

(51) Int. Cl. G06F 3/048; G06F 3/041

(52) U.S. Cl. 715/765; 715/788; 715/794; 345/173

(57) ABSTRACT

An apparatus and method for splitting and displaying a screen of a touch screen are provided. The method includes splitting a screen of the touch screen into at least two display areas in response to an input for splitting the screen, storing split information of the at least two display areas, displaying a plurality of keys on an input display area of the screen, generating and storing key display information in response to the input for splitting the screen, and displaying the plurality keys in a designated location based on the stored key display information.

### PRIORITY

This application claims the benefit under 35 U.S.C. §119(a) of a Korean patent application filed on Mar. 25, 2008 in the Korean Intellectual Property Office and assigned Serial No. 10-2008-27356, the entire disclosure of which is hereby incorporated by reference.

### BACKGROUND OF THE INVENTION

1. Field of the Invention

The present invention relates generally to an apparatus and method for configuring a screen of a touch screen. More particularly, the present invention relates to an apparatus and method for splitting and displaying a screen of a touch screen.

2. Description of the Related Art

Generally, a touch screen of a terminal includes an input area and an output area. The input area includes a plurality of key input areas used for inputting characters associated with the keys. The output area defines an area for displaying input characters and/or data output from the terminal. When a key input occurs on the touch screen of the terminal, a displayed screen of the touch screen is split into an input area and an output area. Certain shapes, sizes and locations of the input display area and the output display area are preset as illustrated in FIGS. 1A and 1B during manufacturing of the terminal. Since the shapes, sizes and locations of the input display area and the output display area are preset, some character keys and menu keys are not normally displayed in the input display area of the screen. Accordingly, some of the character keys and menu keys not displayed in the input display area of the screen may be hidden and displayed upon request. Thus, a request for displaying a specific menu key or character key is made in order to use the corresponding key. Since the shapes, sizes, locations and arrangements of the keys displayed on the input display area are preset during manufacturing of the terminal, the input display area may not be configured as desired.

In order to change the preset input display area of the screen, the terminal may support a conventional edit function for allowing the user to edit key buttons and/or menu icons. With use of the edit function, the user may design a desired input area by editing key buttons and/or menu icons.

However, in this case, the input area may be configured by merely selecting sizes and shapes of the key buttons and/or menu icons provided in an edit tool preset by the terminal manufacturer. Accordingly, configuring a preferred screen of the touch screen may be difficult.

Therefore, a need exists for an apparatus and method for configuring a touch screen of a terminal according to a user's preference.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for splitting and configuring a screen of a touch screen.

Another aspect of the present invention is to provide an apparatus and method for variously transforming keys displayed on a screen of a touch screen.

In accordance with an aspect of the present invention, a method for splitting a screen of a touch screen in a terminal is provided. The method includes splitting a screen of a touch screen into at least two display areas in response to an input for splitting the screen, and storing split information of the at least two display areas.

In accordance with another aspect of the present invention, a method for displaying a screen in a terminal is provided. The method includes generating key display information based on a plurality of keys desired to be displayed on an input display area of the touch screen and based on a location designated to display each of the plurality of keys on the input display area, storing the generated key display information, and displaying each of the plurality of keys on the input display area in a designated location based on the stored key display information.

In accordance with still another aspect of the present invention, an apparatus for splitting a screen of a touch screen in a terminal is provided. The apparatus includes a touch screen for displaying input information generated by an input, a controller for outputting split information for splitting the full display area of the touch screen into at least two display areas in response to the input for splitting a full display area of the touch screen, and a memory for storing the split information under control of the controller.

In accordance with yet another aspect of the present invention, an apparatus for displaying a screen of the touch screen in a terminal is provided. The apparatus includes a touch screen, with a display screen divided into an input display area and an output display area, for displaying a plurality of keys input through the input display area of the touch screen and for displaying location information associated with each of the plurality of keys, a memory for storing key display information, and a controller for generating the key display information using the plurality of keys output from the touch screen and the location information associated with each of the plurality of keys and for controlling the touch screen to display each of the plurality of keys on the input display area in a designated location based on the key display information stored in the memory.

Other aspects, advantages and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIGS. 1A and 1B are diagrams illustrating examples of a conventional terminal mounted with a touch screen;

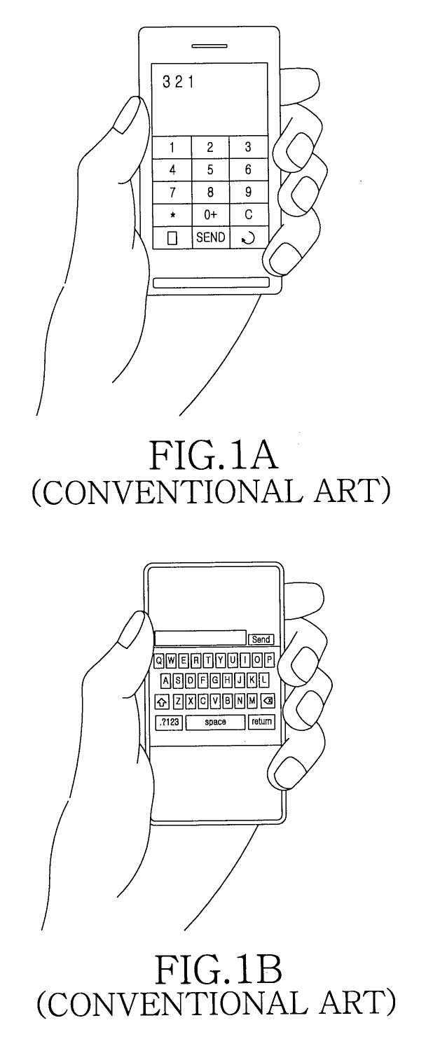

FIG. 2 is a block diagram illustrating a structure of a terminal mounted with a touch screen according to an exemplary embodiment of the present invention;

FIGS. 3A to 3C are diagrams illustrating a touch screen, in which is the screen is split into at least two areas according to an exemplary embodiment of the present invention;

FIGS. 4A and 4B are diagrams illustrating exemplary input display areas formed on a screen of a touch screen according to an exemplary embodiment of the present invention;

FIG. 5 is an exemplary diagram illustrating multiple characters being input on an input display area associated with one key according to an exemplary embodiment of the present invention;

FIG. 6 is an exemplary diagram illustrating an operation for setting a specific function key according to an exemplary embodiment of the present invention;

FIGS. 7A and 7B are diagrams illustrating an exemplary process for changing a size of input/output display areas on a screen of a touch screen according to an exemplary embodiment of the present invention;

FIG. 8 is a flowchart illustrating a process for configuring a screen of a touch screen according to an exemplary embodiment of the present invention;

FIG. 9 is a flowchart illustrating a process of splitting a screen of a touch screen into at least two areas according to an exemplary embodiment of the present invention;

FIG. 10 is a flowchart illustrating a process of displaying a plurality of keys on an input display area of a screen according to an exemplary embodiment of the present invention; and

FIG. 11 is a flowchart illustrating a process for changing a size of input/output display areas on a screen of a touch screen according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A detailed description will now be made of a structure and operation of an apparatus for splitting and displaying a screen of a touch screen upon a user's request in a touch screen of a terminal according to an exemplary embodiment of the present invention. The terminal may be a mobile communication terminal such as a Personal Computer (PC), a mobile phone, a Personal Digital Assistants (PDA), and the like. In the following description, the terminal will be assumed to be a mobile communication terminal. However, it would be obvious to those skilled in the art that an exemplary embodiment of the present invention may be applied not only to the mobile communication terminal but also to any terminal including a touch screen.

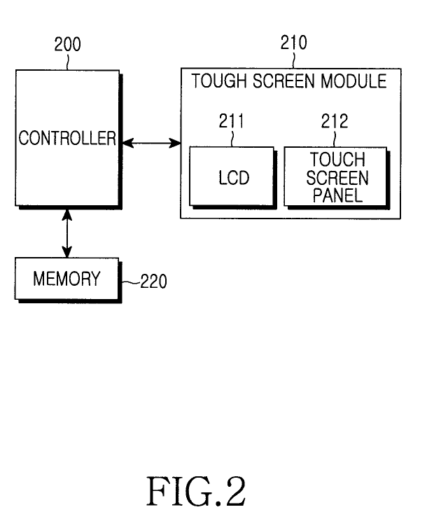

FIG. 2 illustrates a structure of an apparatus for splitting and displaying a screen of a touch screen in a terminal mounted with the touch screen according to an exemplary embodiment of the present invention.

Referring to FIG. 2, a controller 200, which controls an overall operation of the mobile communication terminal, performs a control operation for setting a screen of a touch screen according to an exemplary embodiment of the present invention.

Specifically, the controller 200 determines if a screen setting mode for setting a screen of the touch screen is selected. If the screen setting mode is selected, the controller 200 initializes the screen of the touch screen. The ‘initialization’ denotes setting a state in which no information is displayed on the screen of the touch screen and the user may freely input dots, lines, geometrical figures, characters and the like, thereon using an application, such as Microsoft Paint™, for example.

In the screen setting mode, the controller 200 may perform a screen split mode for splitting a full screen of the touch screen into at least two areas and setting one area as an input display area and another area as an output display area. The controller 200 may also carry out a screen display setting mode for setting/displaying a plurality of keys on the input display area. A more detailed description thereof will be given below.

In an exemplary implementation, the controller 200 determines if the screen split mode for splitting a full screen of the touch screen into at least two areas is selected. If the screen split mode is selected, the controller 200 performs an operation for splitting a full screen of the touch screen. A more detailed description thereof will be made below.

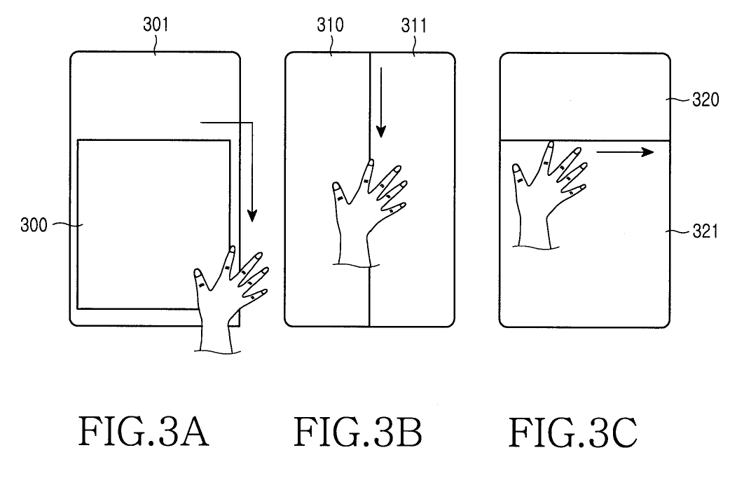

FIGS. 3A to 3C illustrate exemplary screens of a touch screen, each of which is split into at least two areas according to an exemplary embodiment of the present invention.

Referring to FIGS. 3A to 3C, the controller 200 determines if a touch-and-drag input for splitting a full screen of the touch screen into at least two areas is received from the user through a Touch Screen Panel (TSP) 212 within a certain time. If there is no other touch-and-drag input from the user within a certain time after the presence of a specific touch-and-drag input, the controller 200 recognizes a previous touch-and-drag input as a touch-and-drag input for splitting the full screen into at least two areas. The term ‘touch-and-drag’ refers to an input made from the time the user's fingertip or a pointing device, such as a touch pen, contacts a screen of the touch screen, until the time the contact is broken after the contact was continuously maintained for a certain time. Although the touch input is made herein by the user's fingertip, for example, the pointing device, such as a touch pen, may also be used.

A track made by the touch-and-drag input received from the user may be a box shape. Otherwise, the track by the touch-and-drag input may also be a shape connecting an arbitrary point placed in any one of the edges of a screen of the touch screen to an arbitrary point situated in another edge. The full screen of the touch screen may be split by the track into a box-shaped area 300 and the remaining area 301 except for the box-shaped area 300 as illustrated in FIG. 3A. Also, the screen of the touch screen may be split into a first area 310 and a second area 311 as illustrated in FIG. 3B, or into a first area 320 and a second area 321 as illustrated in FIG. 3C.

The controller 200 sets any one of the split areas illustrated in FIGS. 3A to 3C as an input display area and the other area of the split area as an output display area. Thereafter, the controller 200 stores the set split information in a memory 220.

In the foregoing description, the controller 200 splits the screen of the touch screen into at least two areas and sets each of the split areas as an input display area and an output display area. However, the present invention may also display, on a Liquid Crystal Display (LCD) 211, a setting window used for setting each of the spilt areas as an input display area and an output display area, to set the input display area or the output display area according to the user's selection.

The controller 200 determines if the screen display setting mode is selected. If the screen display setting mode is selected, the controller 200 performs an operation for assigning key input areas. A detailed description thereof will be given below.

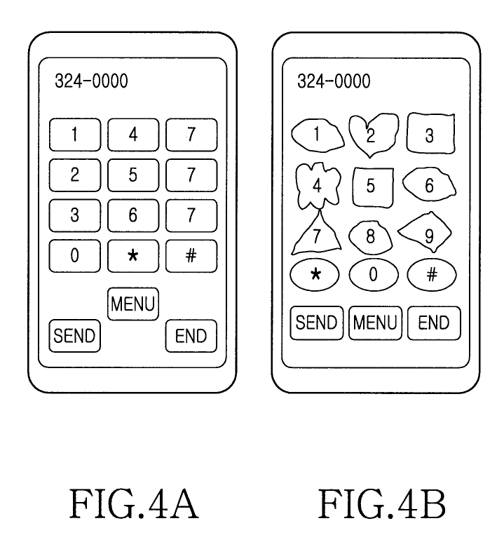

FIGS. 4A and 4B illustrate exemplary input display areas formed on a screen of a touch screen according to an exemplary embodiment of the present invention.

Referring to FIGS. 4A and 4B, the controller 200 determines if a touch input for setting/displaying a plurality of keys on an input display area of a screen is received from the user through a touch screen panel 212 within a certain time. If a touch input for setting/displaying a plurality of keys is received, the controller 200 generates key display information and stores the key display information in the memory 220, to display multiple keys in their designated locations on the input display area of the screen according to the touch input. Accordingly, the present invention may generate the key display information by combining or arranging a plurality of keys selected by the user. Alternatively, the key display information may be generated by combining or arranging a plurality of keys generated by the user. A detailed description thereof will be made below.

For example, if a plurality of keys desired to be displayed on an input area of the touch screen is selected from the user through the touch screen panel 212, the controller 200 determines key combination information used for combining the plurality of selected keys. If a location is selected where each of the multiple keys combined by the determined key combination information is to be displayed on the input display area, the controller 200 determines key arrangement information used for arranging the multiple keys on the selected location. Further, the controller 200 generates key display information based on the determined key combination information and key arrangement information and stores the key display information in the memory 220. An exemplary input display area on the screen, generated using the stored key display information, is illustrated in FIG. 4A.

When a key shape is drawn by the user on the input area of the screen by means of the touch screen panel 212, the controller 200 sets the location, where the key shape is drawn, as key location information and displays the key location information through the LCD 211. The key shape may include various shapes such as a cloud, heart shapes and geometrical figures, such as a circle, an ellipse and the like. When key identification information, such as a numeral, a character and a symbol, is received from the user on the input display area associated with the location where the key shape is drawn, the controller 200 recognizes the received key identification information and displays the received key identification information on the input display area at the location where the key shape is drawn. The key identification information, such as a numeral, a character and a symbol, may be recognized using a character recognition technology, which is well known in the art. The controller 200 generates key display information using the set key location information and the displayed key identification information, and stores the key display information in the memory 220. An exemplary input display area on the screen, generated using the stored key display information, is illustrated in FIG. 4B.

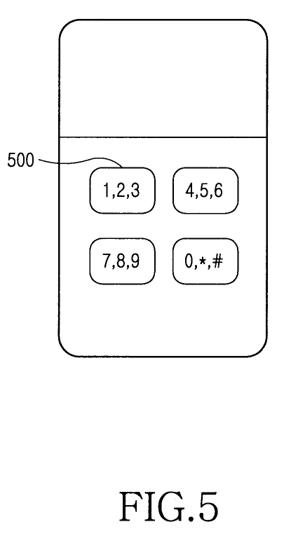

Although a description has been made for an operation of matching the key identification information to the key shape on a one-to-one basis, it is also possible to match a plurality of key identification information to one key shape as illustrated in FIG. 5. Specifically, in this case, when a plurality of key identification information is input on the input display area associated with one key shape, the controller 200 recognizes each input key identification information and sets key display information for displaying all of the recognized key identification information. At this point, the controller 200 sets a number of touch inputs for displaying corresponding key identification information according to their input order and stores the number of touch inputs in the memory 220. For example, the controller 200 sets/stores the number of touch inputs for outputting a numeral ‘1’ as ‘1’, the number of touch inputs for outputting a numeral ‘2’ as ‘2’ and the number of touch inputs for outputting a numeral ‘3’ as ‘3’. If a one-touch input is made on a key input area 500 in the input area formed, as illustrated in FIG. 5, the controller 200 displays a numeral ‘1’ on an output display area of the screen. However, when a three-touch input is made on the key input area 500, the controller 200 displays a numeral ‘3’ on the output display area of the screen.

In addition, the present invention may set function keys used for performing such functions as MENU, OK, SEND, END and the like through the foregoing operation. The present invention may also display a plurality of keys of a keyboard in a QWERTY key format for inputting Korean, English or other language characters on the input display area of the screen.

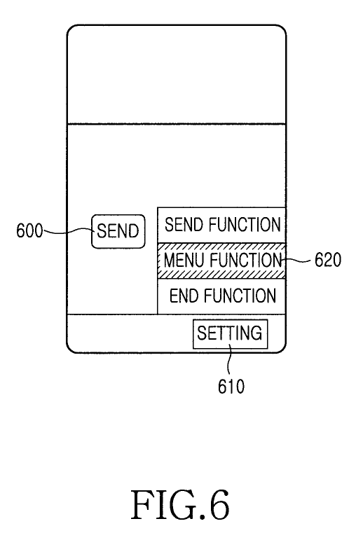

FIG. 6 illustrates an operation for setting/displaying function keys according to an exemplary embodiment of the present invention.

Referring to FIG. 6, when a word, for example, ‘SEND’, is input on an input display area associated with a specified key shape from the touch screen panel 212, the controller 200 recognizes the input word and displays the input word on the input display area associated with the specific key shape. The input display area associated with the specific key shape may be illustrated by reference numeral 600 of FIG. 6. The controller 200 displays on the LCD 211 a terminal's function list including a Send Function, a Menu Function and an End Function, for example, when a request is received through the touch screen panel 212 for setting the input display area 600 where ‘SEND’ is displayed as a function key. When the Menu Function 620 is selected from the function list, the controller 200 may match the input display area 600 where ‘SEND’ is displayed, to the Send Function.

When a word ‘SEND’ is input on the input display area 600 associated with a specific key shape, the controller 200 may also recognize the input word, detect the SEND function associated with the recognized character from the terminal's function list and set the input display area 600 as a SEND key where ‘SEND’ is displayed.

A description has been made for an operation of setting/displaying a plurality of keys on the input display area of the screen according to an exemplary embodiment of the present invention. However, when key identification information is input from the user, the present invention may recognize the input key identification information and display the input key identification information on an input display area associated with the location where the recognized key identification information is input. When a key shape is drawn to include the displayed key identification information, the present invention may set/display the drawn key shape on the input display area.

When a request occurs for displaying a set screen of the touch screen after completing the operation of setting the screen of the touch screen using the SETTING key 610, the controller 200 displays the set screen on the LCD 211. Further, the controller 200 determines if a request for changing a size of the input/output display areas of the screen is received through the touch screen panel 212. A more detailed description thereofwill be given below.

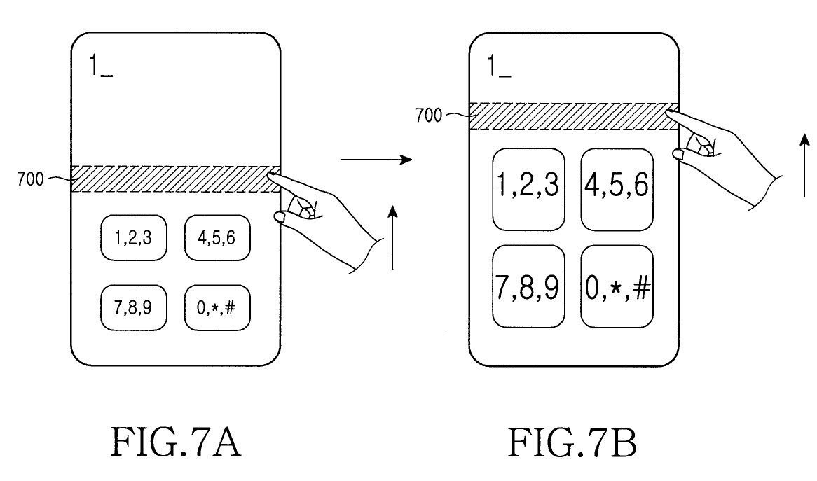

FIGS. 7A and 7B illustrate an exemplary process of setting terminal functions on a specific key input area according to an exemplary embodiment of the present invention.

Referring to FIGS. 7A and 7B, the controller 200 determines if a request for changing a size of input/output display areas on a screen of the touch screen is received through the touch screen panel 212 for a certain time. The present invention may set a specific input display area as a key for changing a size of the input/output display areas on the screen of the touch screen. When a touch input exists for a certain time on an input display area 700 associated with the key for changing a size of the input/output display areas on the screen, the controller 200 waits to perform an operation for changing the size of the input/output display areas. Thereafter, when an input occurs on the corresponding input display area 700 within a certain time to shift in a specific direction, the controller 200 changes the size of the input display area, a size of a key shape displayed on the input display area and the size of key identification information, such as a numeral, a character and a symbol, displayed on the input display area associated with the key shape, at a ratio of the shift distance. Meanwhile, when an input does not occur to shift in a specific direction on the input display area 700 within a certain time, the controller 200 terminates the change and recognizes the non-occurrence of an input as a request for terminating the setting for changing the size of the input/output display areas. In an alternative embodiment, the present invention may display a setting window used for changing a size of the input/output display areas so that the user may directly change the size of the input/output display areas. Although a description has been made for an operation of changing the size of the input display area, the size of the output display area may also be changed in the same manner.

Referring to FIG. 2, the touch screen module 210 is composed of the LCD 211 and the touch screen panel 212. The LCD 211 outputs the data received through the touch screen panel 212 or the data received from the terminal. The touch screen panel 212 outputs a touch input signal, generated by a specific touch input, to the controller 200.

Finally, the memory 220 stores split information used for splitting a screen of the touch screen into at least one input display area and at least one output display area at the user's request. The memory 220 also stores key display information for a plurality of keys that the terminal intends to display on the input display area at the user's request.

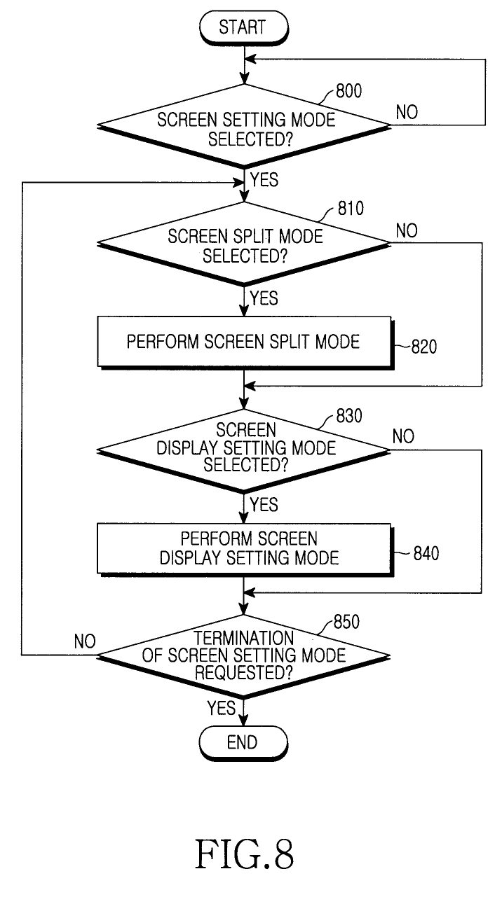

FIG. 8 is a flowchart illustrating a process for configuring a screen of a touch screen according to an exemplary embodiment of the present invention.

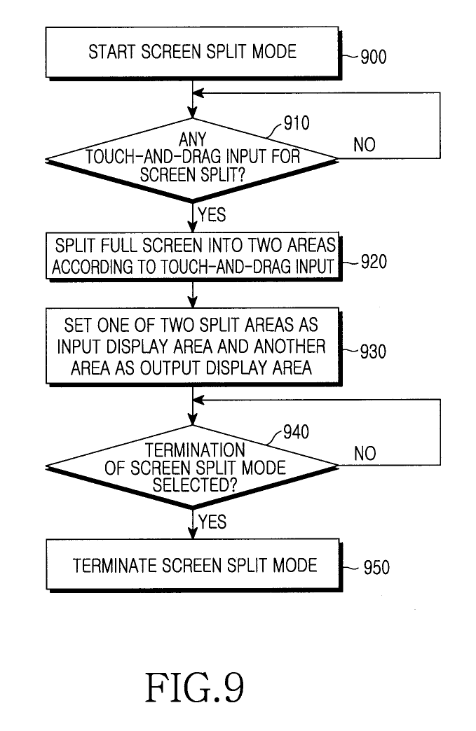

Referring to FIG. 8, in step 800, the controller 200 determines if a screen setting mode for setting a screen of the touch screen is selected. If the screen setting mode is selected, the controller 200 proceeds to step 810. Otherwise, the controller 200 continuously determines whether a screen setting mode is selected in step 800. In step 810, the controller 200 initializes the touch screen and determines if a screen split mode for splitting a full screen of the touch screen into at least two areas is selected. If the screen split mode is selected, the controller 200 proceeds to step 820. Otherwise, if the screen split mode is not selected, the controller proceeds to step 830. In step 820, the controller 200 performs the screen split mode for splitting the full screen of the touch screen into at least two areas. With reference to FIG. 9, a more detailed description will now be made of a process for performing the screen split mode.

FIG. 9 is a flowchart illustrating a process of splitting a screen of a touch screen into at least two areas according to an exemplary embodiment of the present invention.

Referring to FIG. 9, in step 900, the controller 200 starts a screen split mode. In step 910, the controller 200 determines if a touch-and-drag input for splitting the screen is received within a certain time. If the touch-and-drag input for splitting the screen is received within a certain time, the controller 200 proceeds to step 920. Otherwise, the controller 200 continuously determines whether a touch-and-drag input for splitting the screen is received within a certain time in step 910.

In step 920, the controller 200 splits a full screen of the touch screen into at least two areas according to the touch-and-drag input. In step 930, the controller 200 sets any one of the two areas of the full screen split as an input display area and another area as an output display area. The controller 200 stores the set split information in the memory 220.

In step 940, the controller 200 determines if termination of the screen split mode is selected. If termination of the screen split mode is selected, the controller 200 proceeds to step 950 where the controller 200 terminates the screen split mode. Otherwise, the controller 200 continuously determines whether the termination of the screen split mode is selected in step 940.

Referring to step 830 of FIG. 8, the controller 200 determines whether the screen display setting mode for displaying a plurality of keys on the input display area of the screen is selected. If the screen display setting mode is selected, the controller 200 proceeds to step 840. Otherwise, the controller proceeds to step 850.

In step 840, the controller 200 performs the screen display setting mode. The process of performing the screen display setting mode is described below. A description of an exemplary embodiment of the present invention will be made on the assumption that a plurality of keys displayed on the input display area of the screen includes character keys for inputting specific characters. Also, key identification information input by the user is displayed on the input display area associated with the key shape drawn by the user.

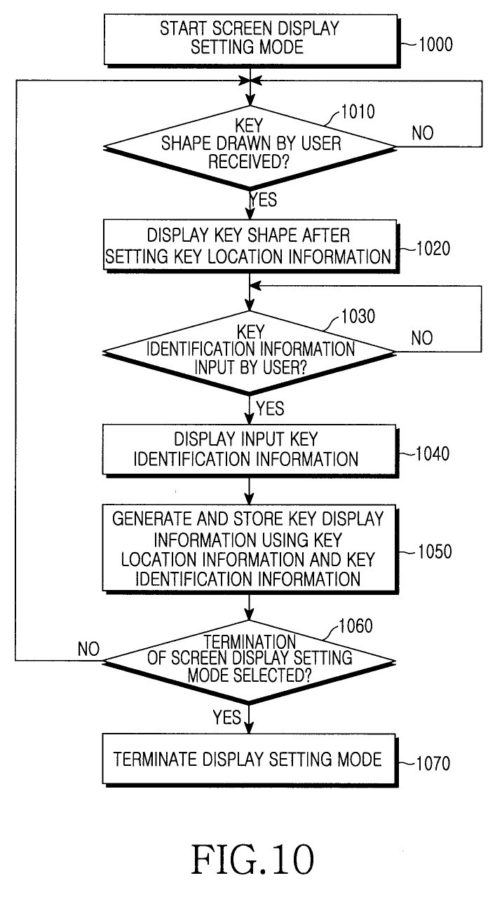

FIG. 10 is a flowchart illustrating a process for displaying a plurality of keys on an input display area of a screen according to an exemplary embodiment of the present invention.

Referring to FIG. 10, the controller 200 starts a screen display setting mode in step 1000. In step 1010, the controller 200 determines whether a key shape drawn by the user is input on the input display area of the screen. If the key shape drawn by the user is input, the controller 200 proceeds to step 1020. Otherwise, the controller 200 continuously determines whether a key shape drawn by the user is input on the input display area of the screen in step 1010.

In step 1020, the controller 200 sets the input display area, associated with the location where the key shape is drawn, as key location information and displays the corresponding key shape on the LCD 211. In step 1030, the controller 200 determines if key identification information, such as a character, is input on the input display area associated with the location where the key shape is drawn by the user. If key identification information from the user is input, the controller 200 proceeds to step 1040. Otherwise, the controller 200 continuously determines whether key identification information, such as a character, is input on the input display area associated with the location where the key shape is drawn in step 1030.

In step 1040, the controller 200 recognizes the input key identification information. Also, the controller 200 displays the recognized key identification information on the input display area associated with the location where the key shape is drawn, by means of the LCD 211. In step 1050, the controller 200 generates key display information based on the set key location information and the input key identification information, and stores the key display information in the memory 220.

In step 1060, the controller 200 determines if termination of the screen display setting mode is selected. If termination of the screen display setting mode is selected, the controller 200 terminates the screen display setting mode. Otherwise, the controller 200 returns to step 1010 and performs succeeding steps 1020 to 1060.

Referring to step 850 of FIG. 8, the controller 200 determines if termination of the screen setting mode is requested. If termination of the screen setting mode is requested, the controller 200 terminates the screen setting mode in step 1070. Otherwise, the controller 200 returns to step 810 and performs succeeding steps 820 to 850. In this manner, the screen of the touch screen may be configured to the user's preference.

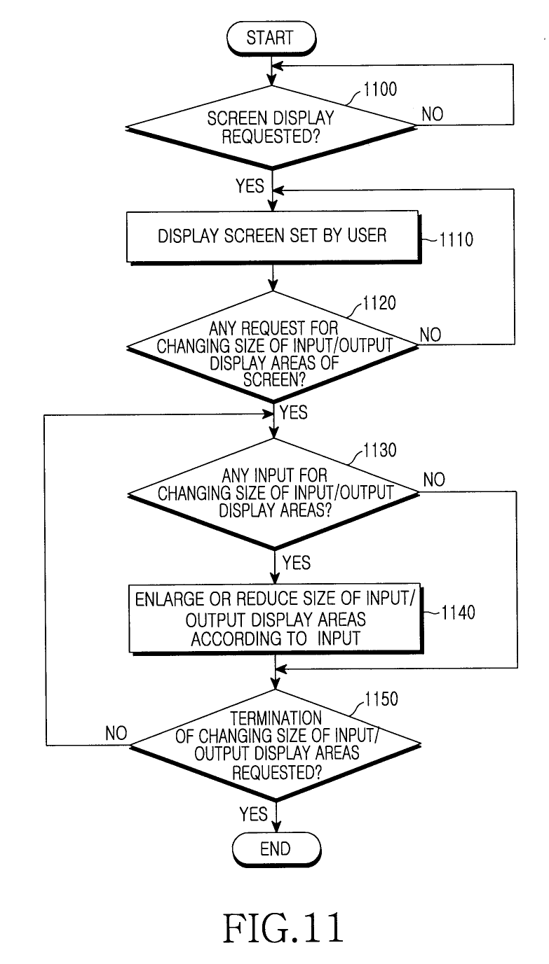

FIG. 11 is a flowchart illustrating a process of displaying a screen of a touch screen according to an exemplary embodiment of the present invention.

Referring to FIG. 11, in step 1100, the controller 200 determines if displaying the configured screen of the touch screen is requested. If the displaying of the configured screen of the touch screen is requested, the controller 200 proceeds to step 1110. Otherwise, the controller 200 continuously determines whether displaying the configured screen of the touch screen is requested in step 1100, while performing a normal function of the terminal.

In step 1110, the controller 200 displays the screen on the LCD 211 set by the user. At this point, the controller 200 may display the screen based on the split information and key display information stored in the memory 220.

In step 1120, the controller 200 determines if changing a size of input/output display areas of the screen is requested. If the changing of the size of input/output display areas of the screen is requested, the controller 200 proceeds to step 1130. Otherwise, the controller 200 returns to step 1110 and continues to display the screen.

In step 1130, the controller 200 determines if changing a size of the input/output display areas is input. If the changing of the size of the input/output display areas is input, the controller 200 proceeds to step 1140. Otherwise, the controller 200 proceeds to step 1150.

In step 1140, the controller 200 enlarges or reduces a size of any one of the displayed input/output display areas according to the input for changing the size of the input/output display areas. In an exemplary implementation, when a size of any one area is enlarged, a size of another area is reduced.

In step 1150, the controller 200 determines if terminating the setting for changing the size of the input/output display areas is requested. If the terminating of the setting for changing the size of the input/output display areas is requested, the controller 200 terminates the setting. Otherwise, the controller 200 returns to step 1130 and performs succeeding steps 1140 to 1150. Accordingly, the screen of the touch screen may split into at least two areas and display a plurality of keys set by the user on the input display area out of the split areas. Thereby the screen may be configured according to the user's preference.

As is apparent from the foregoing description, exemplary embodiments of the present invention split a screen of the touch screen into at least two areas at a user's request and set the two areas as an input area and an output area, respectively. Further, exemplary embodiments of the present invention display a plurality of keys on the input display area constituting the screen upon the user's request. As a result, it is possible to provide a screen according to the user's preference.

In addition, the users may directly design their own desired keys. Accordingly, inconvenience caused by a fixed setting of sizes, shapes and arrangements of the keys displayed on the input display area is prevented.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A method for splitting a screen of a touch screen in a terminal, the method comprising:
splitting a screen of a touch screen into at least two display areas in response to an input for splitting the screen; and
storing split information of the at least two display areas.

2. The method of claim 1, further comprising initializing a full screen of the touch screen upon request.

3. The method of claim 1, wherein the at least two display areas comprise at least one input area for displaying a plurality of key input areas and at least one output area for displaying display information output from the terminal.

4. The method of claim 3, wherein one of the at least two display areas is formed by a track generated according to the input.

5. The method of claim 4, further comprising:
outputting the spilt information for splitting the full screen, when a request for outputting the split is received after storing the split information;
determining whether a size change of the at least two display areas is input; and
changing the size of the at least two display areas displayed when a size change is input.

6. A method for displaying a screen of a touch screen in a terminal, the method comprising:
generating key display information based on a plurality of keys desired to be displayed on an input display area of the touch screen and based on a location designated to display each of the plurality of keys on the input display area;
storing the generated key display information; and
displaying each of the plurality of keys on the input display area in a designated location based on the stored key display information.

7. The method of claim 6, wherein the generation of the key display information comprises:
when a plurality of keys desired to be displayed on the input display area of the touch screen is selected, determining key combination information of the selected keys;
when a location where each of the selected keys is to be displayed on the input display area is selected, determining key arrangement information of the selected location; and
generating the key display information based on the determined key combination information and the determined key arrangement information.

8. The method of claim 6, wherein the generation of the key display information comprises:
when a key shape is drawn on the input display area of the touch screen, setting a location where the key shape is drawn as key location information;
when key identification information is input on the input display area at the location where the key shape is drawn, displaying the input key identification information on the input display area at the location where the key shape is drawn; and
generating the key display information based on the set key location information and the displayed key identification information,
wherein the key identification information comprises at least one of a numeral, a character and a symbol written on the input display area at the location where the key shape is drawn.

9. The method of claim 8, wherein the key display information further comprises information regarding the key shape drawn on the input display area of the touch screen.

10. The method of claim 9, wherein the key shape comprises a closed loop including an area sufficient to display the key identification information input.

11. The method of claim 6, further comprising:
when at least one of the plurality of keys displayed on the input display area is touched, displaying the touched key on an output display area of the touch screen.

12. An apparatus for splitting a screen of a touch screen in a terminal, the apparatus comprising:
a touch screen for outputting input information generated by an input;
a controller for outputting split information for splitting the full display area of the touch screen into at least two display areas in response to the input for splitting a full display area of the touch screen; and
a memory for storing the split information under control of the controller.

13. The apparatus of claim 12, wherein the controller initializes the touch screen to a state in which no information is displayed on the full display area of the touch screen.

14. The apparatus of claim 12, wherein the at least two display areas comprise at least one input area for displaying a plurality of key input areas and at least one output area for displaying display information output from the terminal.

15. The apparatus of claim 14, wherein one of the at least two display areas is formed by a track generated according to the input.

16. The apparatus of claim 15, wherein the controller controls the output of spilt information for splitting the full display area of the area of the touch screen into at least two display areas, when a request for outputting the split is received after storing the split information, determines whether changing a size of the display of the at least two display areas is input, and changes the size of the display of the at least two display areas when a size change is input.

17. An apparatus for displaying a screen of a touch screen in a terminal, the apparatus comprising:
a touch screen, with a display screen divided into an input display area and an output display area, for displaying a plurality of keys input through the input display area of the touch screen and for displaying location information associated with each of the plurality of keys;
a memory for storing key display information; and
a controller for generating the key display information using the plurality of keys output from the touch screen and the location information associated with each of the plurality of keys and for controlling the touch screen to display each of the plurality of keys on the input display area in a designated location based on the key display information stored in the memory.

18. The apparatus of claim 17, wherein the controller determines key combination information of the selected keys, when a plurality of keys desired to be displayed on the input display area of the touch screen is selected, determines key arrangement information of the selected location, when a location where each of the selected keys is to be displayed on the input display area is selected, and generates the key display information based on the determined key combination information and the determined key arrangement information.

19. The apparatus of claim 17, wherein the controller sets a location where the key shape is drawn as key location information, when a key shape is drawn on the input display area of the touch screen, setting, controls the touch screen to display the input key identification information on the input display area at the location where the key shape is drawn, when key identification information is input on the input display area at the location where the key shape is drawn, and generates the key display information based on the set key location information and the displayed key identification information, wherein the key identification information comprises at least one of a numeral, a character, and a symbol written on the input display area at the location where the key shape is drawn.

20. The apparatus of claim 19, wherein the key display information further comprises information regarding the key shape drawn on the input display area of the touch screen.

21. The apparatus of claim 20, wherein the key shape comprises a closed loop including an area sufficient to display the key identification information input.

22. The apparatus of claim 17, wherein, when at least one of the plurality of keys displayed on the input display area is touched, the controller controls to display the touched key on an output display area of the touch screen.
